(19) United States
(12) Patent Application Publication
(10) Pub. No.: US 2019/0110461 A1
(43) Pub. Date: Apr. 18, 2019

(54) Method and apparatus for identifying, locating and scaring away birds

(71) Applicant: Paul Caskey, Perkiomen, PA (US)

(72) Inventor: Paul Caskey, Perkiomen, PA (US)

(21) Appl. No.: 15/784,107

(22) Filed: Oct. 14, 2017

(51) Int. Cl. A01M 29/10; A01M 29/18; B64C 39/02

(52) U.S. Cl. CPC A01M 29/10; A01M 29/18; B64C 2201/145; B64C 2201/12; B64C 39/024

(57) ABSTRACT

Provided is a method by which birds can be detected in a large outdoor area that may be a farmer's field or an international airport runway. Employing multiple cameras, a computer vision system will detect and identify bird flocks and calculate the location where they are flocking and/or landing. The GPS coordinates of the flock location are sent to an autonomous drone that will immediately launch and fly to that location. Once at the general location of the flock, the drone can fly any type of pre-programmed pattern, from simple circles to any complex patter of turns.

Birds have long been a problem to the agriculture industry because of the devastating damage they can do to a crop in a very short period of time, or even dig up planted seed before the crop starts to grow. This invention will save untold time and expense to a wide range of growers.

In addition to agriculture, this invention will be used to improve safety at airports chasing birds off runway approaches and any other places where birds present a nuisance or safety hazard. The drone has the ability to maintain an accurate low-altitude flight, typically less than 50′ above ground level, well below altitude of approaching aircraft.

### BACKGROUND OF THE INVENTION

### 1. Field of the Invention

The present invention relates to a method and an apparatus for bird control using computer vision and unmanned aerial vehicles. The field of applications is broad from farmers repelling birds to save valuable crops to international airports who have safety issues with birds on approaches to runways.

### 2. Description of the Related Art

In recent years the number of bird species has rapidly increased due to the social environment and bird protection activities of environmental protection groups. This population growth increases pressures on potential users to have an increasing problem with birds.

Discouraging birds has long been an issue with growers as long as they have been growing. There is a wide array of products to chase birds, from the old tin pie pan, to audio recordings of birds in distress, to spray-on remedies.

At airports, as an effort, a method of repelling the birds by installing a bird stress sound system and an alarm system in a green zone adjacent to a runway and periodically activating the systems as an alarm is primarily used and in some cases, a method of repelling the birds by safety officers (BAT team)′ firing a hunting gun or air gun is also used.

Another method of spraying chemicals is also used as a repellant of birds or make the crops “taste bad” so the birds don't eat the crops. Time and materials to spray crops every six days is high and has inconsistent results. Additionally, farmers are reluctant to spray chemicals on their high value crops as they ripen for harvest.

It seems all known repellant methods from the tin pie pan to sonic and ultrasonic audio recordings, birds will learn they are not a threat and after a short time become immune to any noise maker or motion apparatus.

One company specializing in bird repellents, Bird-X, offers a drone, emitting sounds and light to scare birds, but must be flown manually, or at least have an operator present to launch an autonomous flight. Their drone also has no means of detecting birds other than human operator(s) identifying damaging bird flocks.

The most effective and possibly the most costly method at this time is to hire one or more full time employees actively patrol the area on a motorized golf cart or ATV and “manually” scare birds by firing noise-making devices propelled by gas or gunpowder.

The systems and apparatus described in this application will locate and “chase” birds in a random way and the drone device will always be viewed as a predator. Birds can learn a pie pan isn't a threat and conversely, they will learn the drone poses a serious perceived threat and may train the birds to stay out of the patrolled areas.

### SUMMARY OF THE INVENTION

The invention described herein presents a solution to a long-standing problem for many growers and other industries throughout the world. The problem is birds infiltrating and destroying high-value crops, such as grapes or berries, or presenting a hazard to landing jets at an airport.

No good solution exists that is tenable or isn't subject to ongoing expenses and/or birds learning the repellant methods rendering them useless.

Leveraging the current state of video processing and computer vision software, the invention will use video cameras in the field to identify birds and bird flocks based on their color, size, movement and other parameters. After the birds are identified, the flock size will be assessed, their motion will be studied and based on a detailed “recipe”, a proprietary algorithm will determine the state of the birds. They may be out of the range of the area of interest, may be passing over, or may be identified as birds that need to be scared away from the patrolled area.

The user or technician will install cameras at optimal locations high enough on poles or buildings to have a good view of the field, orchard, vineyard, runway, etc. Upon installation, the installer will accurately record the GPS coordinates of the camera. The actual UAV, having RTK GPS with cm-level accuracy can be used to determine the GPS coordinates of each camera or a stand-alone GPS locating device can be used. The installer will also have to record the compass headings for the direction each camera is facing. With calibrated camera azimuth, a flock can be identified as located on a specific compass heading (radial) from a given camera. Knowing the position of each camera and the flock's position relative to two or more cameras, their location can be calculated through triangulation.

If more than two cameras are observing the same area, the computer vision system (CVS) data output becomes more accurate. Al and deep learning techniques will improve the bird behavior algorithms not only for the user's specific location but also for future learning and software updates.

When the CVS makes the determination birds are present and need to be chased away, it will send an alarm to the drone control unit (DCU) which will start the launch procedure.

The UAV flight path is mostly pre-programmed; The takeoff command, altitude, airspeed, pattern to fly when the target location is reached and the return to launch command are already set in the code. The only remaining piece of information needed by the UAV to start the mission is the GPS coordinates of the birds as calculated by the CVS. Upon receiving the alarm, the DCU will receive the flock coordinates from the CVS and upload that data to the UAV. The UAV, set for launch, will autonomously fly to the coordinates calculated by the localizer, fly a predetermined pattern and return to the home location.

### BRIEF DESCRIPTION OF THE FIGURES

The drawings are described in order to more fully appreciate drawings cited in the detailed description of the present invention;

FIG. 1 Diagram showing an overview of the system and its operation with two camera coverage.

FIG. 2 Diagram showing an overview of the system and its operation with single camera coverage.

FIG. 3 Installing camera, measuring azimuth. Also shown is a WiFi high-gain patch antenna.

FIG. 4 Measuring the GPS coordinates of the camera location using the drone's onboard GNSS RTK (GPS).

FIG. 5 Base station components block diagram overview.

FIG. 6 Unmanned aerial vehicle (UAV), aka drone, subsystems

### DETAILED DESCRIPTION OF THE PREFERRED EMBODIMENTS

Hereinafter, embodiments of the present invention will be described with reference to the accompanying drawings.

The present invention relates to an apparatus for bird control using video cameras, video processing, computer vision algorithms, deep learning and autonomous drone(s) for the purpose of identifying, locating and discouraging birds in a given area of interest. Applications fall mainly in the agriculture and farming, but many other bird chasing applications exist such as chasing birds from runways, golf courses or any other place birds represent a nuisance or hazard.

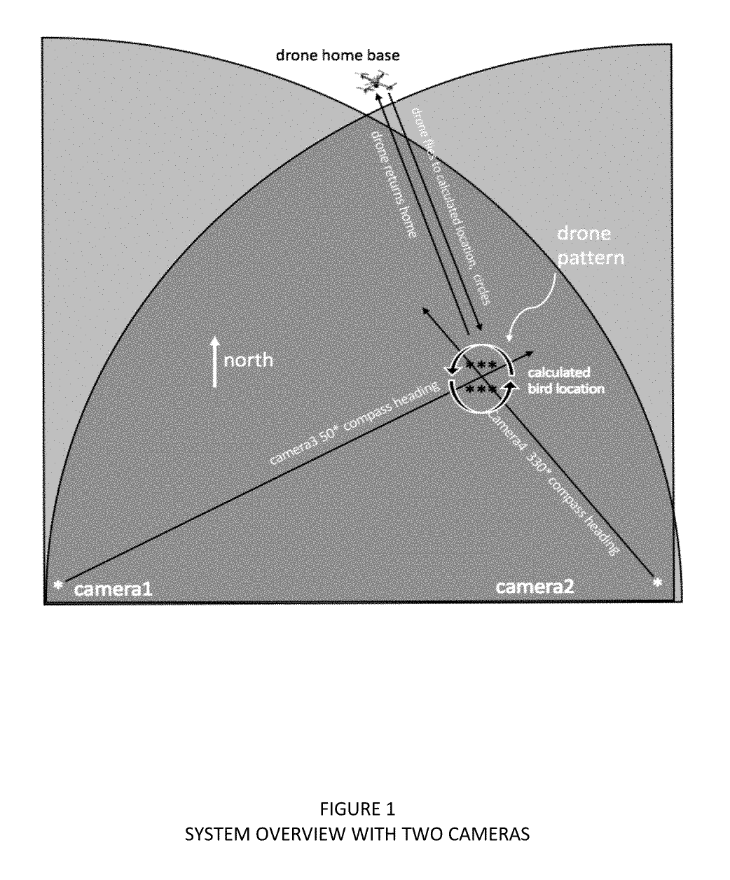

FIG. 1 is a diagram showing a broad system configuration overview to which an apparatus for controlling birds using computer vision and an unmanned aerial vehicle is applied according to the present invention. In this figure, the birds are present where two cameras have overlapping video surveillance coverage. Having two or more cameras covering a location improves accuracy and permits triangulation of the flock's estimated center.

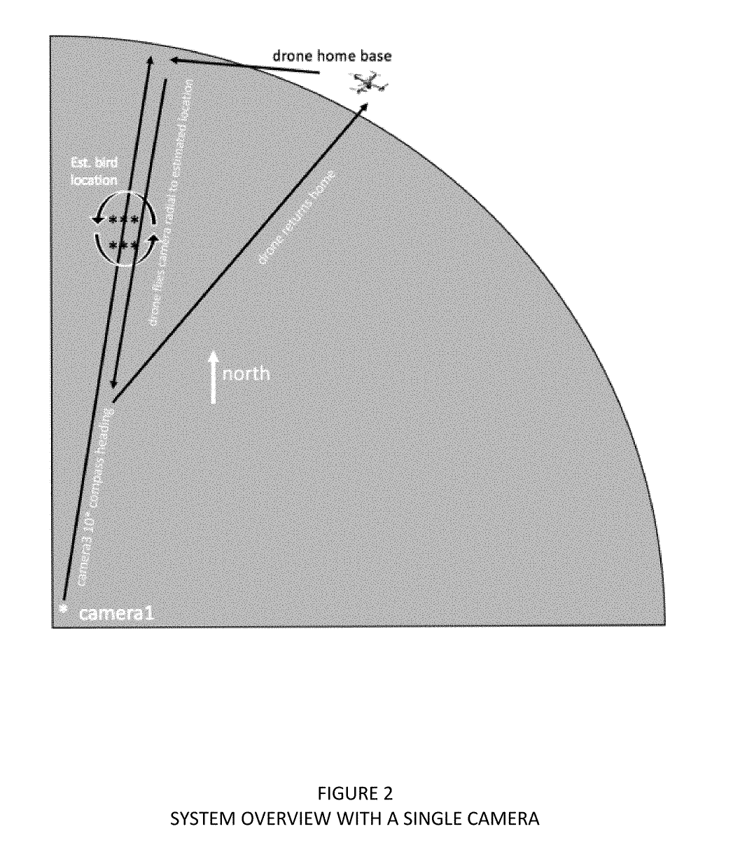

FIG. 2 shows a case when birds are present where there is no overlapping coverage and only a single camera has the birds in its view. The bird detection and identification algorithms will identify the bird group and compass radial from the camera where the flock is located as well as provide an estimated distance. While not quite as accurate as having two or more cameras to provide triangulation location, the pattern flown by the drone will be altered to cover a larger area and compensate for the lowered accuracy.

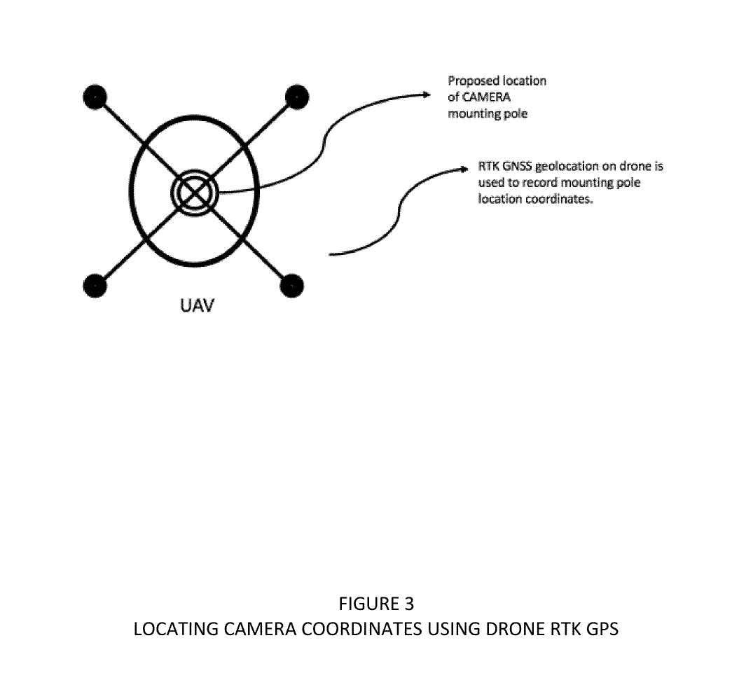

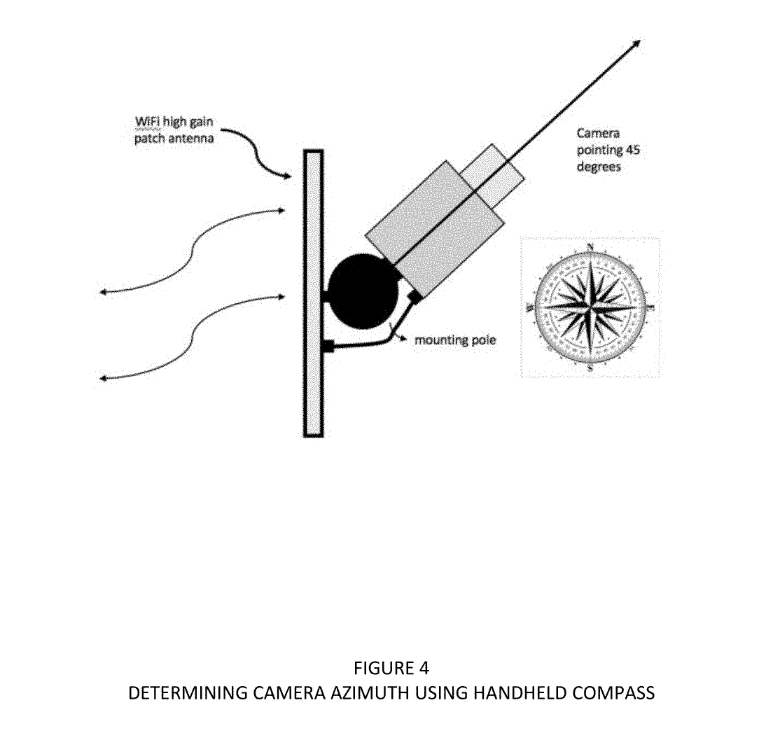

Each camera is elevated so it has an unobstructed view of the field. Using the highly-accurate RTK GNSS (GPS), either stand-alone systems or the GPS mounted on the aerial vehicle, the location of each camera is recorded with an accuracy if about 2 cm. To use the drone to determine the camera locations, the drone is simply powered up and taken to the proposed camera location as shown in FIG. 3. Centimeter-level accuracy is achieved using the drone's RTK GNSS (GPS). In addition to accurately measuring the geolocation of each camera, the direction of view is measured for each camera using a hand held compass. The camera setup is illustrated in FIG. 4.

Each camera can have a built-in WiFi interface, to wirelessly transmit the video images back to the base station or be hard-wired to the base station. High-gain patch or other type antennas may be used to increase reliability of the wireless point-to-point connection from the camera to the base station receiver. FIG. 2 shows a patch antenna transmitting the signal back to the base station.

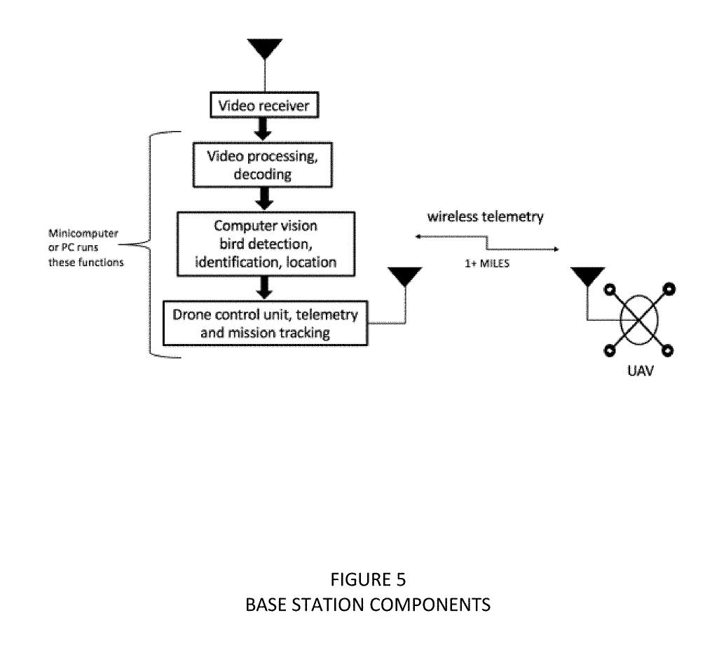

The “base station” comprises all the hardware, computers and software needed to complete all tasks and processes and is shown in FIG. 5. The components of the base station are typically collocated, but this is not a requirement, should other factors come into play.

The hardware includes:
1. Video receiver—via wireless or hard-wired
2. Video processing unit (VPU) converts encoded video to HDMI, component, or other video format compatible with the computer vision processor.
3. Computer vision system (CVS) receives video and using computer vision techniques, identifies flocks and their locations.
4. Drone control unit (DCU) receives flock location data from CVS, and wirelessly programs the drone auto mission. The DCU launches, tracks drone throughout mission and landing.
5. Drone equipped with flight management unit (FMU), RTK GPS, and telemetry system auto flies mission.

The wired or wireless video receiver, typically located at the base station, receives the encoded video signal from each camera and sends the combined digital signal to the video processing unit (VPU). The VPU processed the video signals as needed and sends them to the computer vision system (CVS). The video output format from the VPU can also be monitored using any commonly accepted format such as HDMI, component or USB.

The VPU processes the digital video as necessary and sends the individual video streams to the computer vision system (CVS). The CVS performs a number of video processing functions detecting, identifying and locating groups or flocks of birds.

The CVS monitors all video camera streams for the presence of birds. If an area only has coverage by one camera, the CVS will be looking for bird patterns for recognition and radial location. If an area has coverage by two or more cameras, the video information along with each camera's location and orientation, the CVS can calculate the GPS coordinates of the estimated center of the flock using triangulation. As flocks are tracked by two or more cameras, their location will be continually updated using the triangulation method.

The CVS will use one or more algorithms to identify bird movement, color, flock patterns, flock size, flock angular rotation with respect to the camera in view among many other parameters. The CVS will also incorporate computer learning and artificial intelligence (Al) techniques to learn bird behaviors and patterns. When the CVS's algorithms determine a flock has landed, or is an imminent risk to an area, it sends an alarm flag to the drone control unit (DCU).

The video processing and computer vision algorithms can run on a dedicated mini-computer or notebook/laptop/tower computer.

The drone control unit (DCU) receives an alarm flag from the CVS, wakes up and asks for the data about the detected flock, including, camera number(s), radial location of the birds with respect to each camera, coordinates of the flock if available.

Once the DCU has the mission data, the flight plan can be finalized and wirelessly uploaded to the aircraft. Most of the flight plan parameters and commands are already known, such as takeoff, flight altitude, flight, speed, and the only parameter needed to complete the flight plan is the birds' location. One or more script(s) will run on Mission Planner or other ground control station (GCS) to upload the missions, monitor system data and perform other Ground Control Station (GCS) functions.

Mission Planner is one such open-source ground control station that runs the MAVlink (Micro Aerial Vehicle link) protocol configured to run independent control of the UAV through Python scripts. In this instance script running in Mission Planner will use the flock GPS coordinates supplied by the CVS to and enter that value as a waypoint in the mission.

The mission commands script will be something similar to:
1. Run check all systems and subsystems
2. Turn on bird deterrent device(s)—This will also alert any people in the area of the drone activity
3. Arm UAV—checks on health of all systems again, arm if OK.
4. Takeoff—execute takeoff
5. Set Altitude—set mission height above ground level (AGL). Altitude AGL will be accurately measured and maintained by use of sonar/IR ground sensors to hold the aircraft at an exact height AGL.
6. Set mission speed
7. Proceed to flock location waypoint
8. At flock waypoint, fly pattern—pattern could be a circle or circles of any speed or size, or a more complex pattern of turns if desired. The pattern flown is user configurable
9. Return to home
10. Land

Using wireless telemetry, all UAV systems and operations are monitored and logged throughout the mission.

The drone control functions can run on a dedicated mini-computer or any notebook/laptop/tower computer.

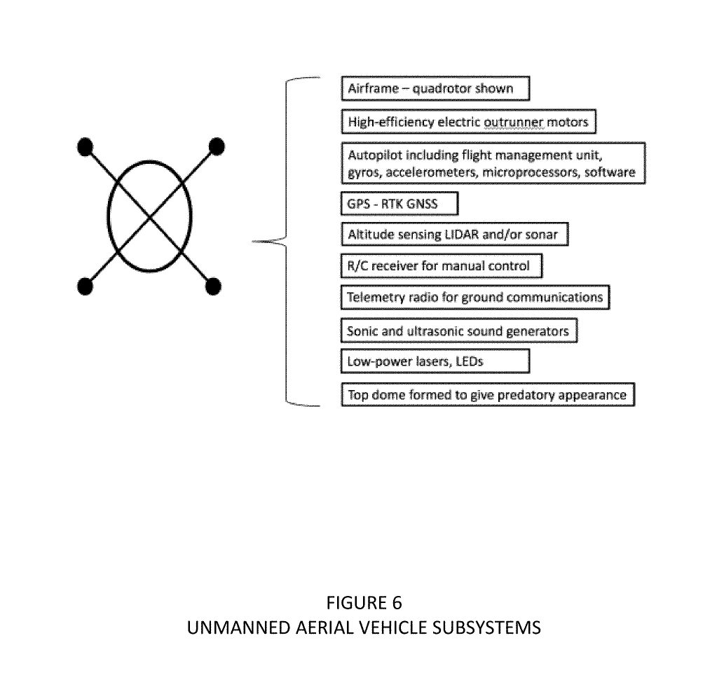

The unmanned aerial vehicle (UAV), or drone is designed specifically for the purpose of chasing birds. It has all the requirements of an autonomous aerial vehicle and also includes bird chasing hardware. A representation of a typical UAV and subsystems is shown in FIG. 6.

The typical components of an autonomous bird chasing UAV include:
1. Airframe—quadrotor, hex-rotor, fixed wing
2. Motor(s)—electric outrunner motors
3. Autopilot—includes flight management unit, gyros and accelerometers for attitude control, magnetometers for compass heading information, microprocessor(s) and flight control software
4. GPS—real time kinematic (RTK) global navigation satellite system (GNSS) is used for very accurate global position measurement
5. Altitude and positioning devices—include ultrasonic and/or light detection and ranging (LIDAR) for accurate altitude and landing location calculation
6. R/C communications—Standard RC transmitter receiver.
7. Telemetry radio—interfaces with FMU and sends/receives data to/from the ground control station (GCS).
8. Sound generator(s)—including sonic and ultrasonic devices for scaring birds
9. Lasers—low-power lasers have been shown to scare birds
10. Appearance—drone outward appearance will be such that it appears predatory to birds

In addition to the hardware and software required for autonomous flight, the UAV will also have an array of bird repellent devices. These devices include the look, sound and prop-wash (blowing air) of the drone itself, sonic and ultrasonic devices, lasers, LED lighting and any other methods available that can be mounted on a UAV keeping total weight under 55 lbs to meet FAA regulations.

What is claimed is:

1. The invention is a system and apparatus for bird control using computer vision and deep learning techniques, to direct the flight path of autonomous unmanned aerial vehicle(s) (UAV), more commonly referred to as drones. The terms UAV and drone can be used interchangeably for the purpose of this application.
Video cameras are placed throughout the area to be protected from birds and the captured video is hard-wired or wirelessly transmitted back to a base station. Video processing and computer vision systems (CVS) will monitor the video from each camera and using a system of algorithms will identify groups or flocks of birds and their relative location (radial) with respect to each specific camera. The CVS will monitor the area(s) of interest “looking” for birds, and use a series of algorithms to determine the size of the flock, if the flock has slowed or stopped, landed and myriad other behavioral characteristics. Deep computer learning and artificial intelligence will be employed to learn bird behavior and improve predictive systems and overall accuracy.
The various video processing and computer vision software can run on stand-alone mini-processors or be run on laptops or full-size tower computers.
When the CVS makes the decision to send out a drone, it transmits a string of data to the drone control unit (DCU) identifying the camera(s) that have located the birds and the birds' estimated GPS location. The DCU wirelessly programs the drone to autonomously take off and fly to the birds' location determined by the CVS. Once at the birds' location the drone will fly a user-defined pattern and employ sonic/ultrasonic audio devices and/or lasers and/or any other applicable means of scaring the birds. After flying the mission, the drone will autonomously return to the base station and land.
The base station will also include a charging pad for the drone to land on and charge the batteries.

2. The method of section 1; requires that upon installation of each camera an accurate measurement of the camera's geolocation coordinates and direction the camera is “pointing” are recorded. This data is entered in to the computer vision (CVS) through a graphical user interface.

3. The method of section 1; a proprietary computer vision system (CVS) employs video processing, computer vision and artificial intelligence functions to accurately detect and identify the presence of birds and their estimated or calculate their location. Computer learning and artificial intelligence will improve system performance at each specific location and overall performance over time.

4. The method of section 1; using computer vision algorithms, the computer vision system (CVS) computes the compass angle of the estimated center of a flock relative to each camera and estimates or calculates the birds' location depending on camera coverage.

5. The method of section 1; the computer vision system (CVS) computes the compass angle of the estimated center of a flock relative to each camera and if the birds are identified by two or more cameras, knowing the camera location and orientation, the flock location can be accurately calculated by simple triangulation.

6. The method of section 1; leverages proprietary algorithms to track the birds' behavior and “decide” whether to send an alarm to the drone control unit (DCU) or not. When an algorithm trip point occurs, the CVS will send an alarm to the DCU and provide the flock location data to launch one or more drones to chase the birds away.

7. The method of section 1; uses hard-wired or wireless video transmission methods to send video back to the computer vision system—typically, but not necessarily, collocated with the UAV and DCU.

8. The method of section 1; drone control unit (DCU) wirelessly communicates with the UAV (drone), uploads the mission parameters and flock position data from the CVS. The DCU launches the UAV and maintains telemetry data on drone functions.

9. The method of section 1; has a fully autonomous UAV that is capable of takeoff, flying at a user-specified height, specified speed and fly predetermined pattern upon reaching target, then return to home and land. All systems required for autonomous flight, RTK GPS tracking and telemetry for communication with base station are contained within the drone.

10. The method of section 9; autonomous drone location systems will use Real Time Kinematic (RTK) satellite navigation to enhance the precision of position data derived from global navigation satellite systems (GNSS). Additional sonar and/or IR guidance systems, will provide <2 cm accuracy when landing to make practical the use of a drone charging station (DCS) that automatically charges the drone between missions.

11. The method of section 9; the fully autonomous UAV (drone) will have several methods onboard to scare birds. These methods include, but are not limited to the drone itself, camouflaged as a predator, the noise and prop-wash of the flying drone, addition sonic and ultrasonic bird scaring sound makers and low-power lasers.

12. The method of section 9; provides a manual RC transmitter/receiver for manual control or override of drone flight.
